(19) United States
(12) Patent Application Publication
(10) Pub. No.: US 2026/0061287 A1
(43) Pub. Date: Mar. 5, 2026

(54) VISIBILITY ASSISTANCE SYSTEM USING A PORTABLE DEVICE

(71) Applicant: Textron Inc., Providence, RI (US)

(72) Inventors: Aishwarya Arun, Augusta, GA (US); Brian David Wanta, North Augusta, SC (US); Cole Elliott O'Brien, North Augusta, SC (US)

(73) Assignee: Textron Inc., Providence, RI (US)

(21) Appl. No.: 18/816,142

(22) Filed: Aug. 27, 2024

(51) Int. Cl. A63B 71/06; A63B 24/00; G08B 7/06

(52) U.S. Cl. CPC A63B 71/0622; A63B 24/0062; A63B 2220/12; G08B 7/06

(57) ABSTRACT

A golf lookahead system includes a portable device carried by a first golfer and a server configured to communicably couple with the portable device and a secondary device associated with a second golfer. The server is configured to acquire first location information regarding the portable device and second location information regarding the secondary device, determine the second golfer is ahead of the first golfer, determine an alert condition is present, transmit a first signal to the portable device, determine the alert condition is no longer present, and transmit a second signal to the portable device. In response to the first signal, the portable device warns the first golfer regarding the second golfer and in response to the second signal, the portable device notifies the first golfer that the shot can be taken.

### BACKGROUND

Golf carts are commonly used by golfers while playing a round of golf to drive between holes, to their ball, and to carry their bags. In some cases, golfers walk the round of golf instead of using golf carts. Sometimes, a first golfer at one position on the golf course may be out of view but potentially in the way of a second golfer teeing off on the same hole. In such situations, neither the first golfer nor the second golfer may have a way of knowing that the first golfer is at risk of being struck by the second golfer's tee shot.

### SUMMARY

One embodiment relates to a golf lookahead system for a golf course. The golf lookahead system includes a portable device configured to be carried by a first golfer and a server configured to communicably couple with the portable device and a secondary device associated with a second golfer. The servicer is configured to acquire first location information regarding the portable device; acquire second location information regarding the secondary device; determine the second golfer is ahead of the first golfer on a respective hole of the golf course based on the first location information and the second location information; determine an alert condition is present based on the first location information and the second location information; transmit a first signal to the portable device, where the portable device is configured to warn the first golfer regarding the second golfer in response to the first signal to prevent the first golfer from taking a shot; determine the alert condition is no longer present; and transmit a second signal to the portable device, where the portable device is configured to notify the first golfer that the shot can be taken in response to the second signal.

Another embodiment relates to a golf lookahead system for a golf course. The golf lookahead system includes one or more processors configured to acquire first location information regarding a first device associated with a first golfer; acquire second location information regarding a secondary device associated with a second golfer, where at least one of the first device or the secondary device comprises a portable device; determine the second golfer is ahead of the first golfer on a respective hole of the golf course based on the first location information and the second location information; determine an alert condition is present based on the first location information and the second location information; transmit a first signal to the first device, where the first device is configured to warn the first golfer regarding the second golfer in response to the first signal to prevent the first golfer from taking a shot; determine the alert condition is no longer present; and transmit a second signal to the first device, wherein the first device is configured to notify the first golfer that the shot can be taken in response to the second signal.

Still another embodiment relates to a golf lookahead system. The system includes a non-transitory computer-readable medium having instructions stored thereon that, when executed by one or more processors, cause the one or more processors to acquire first location information regarding a portable device configured to be carried by a first golfer on a golf course; acquire second location information regarding a secondary device associated with a second golfer on the golf course; determine the second golfer is ahead of the first golfer on a respective hole of the golf course based on the first location information and the second location information; determine an alert condition is present based on the first location information and the second location information; transmit a first signal to the portable device, wherein the portable device is configured to warn the first golfer regarding the second golfer in response to the first signal to prevent the first golfer from taking a shot; determine the alert condition is no longer present; and transmit a second signal to the portable device, wherein the portable device is configured to notify the first golfer that the shot can be taken in response to the second signal.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a front view of a portable device, according to an exemplary embodiment.

FIG. 4 is a schematic block diagram of a site monitoring and control system including one or more of the vehicles of FIG. 1 and/or one or more of the portable devices of FIG. 3, according to an exemplary embodiment.

FIGS. 5A-5C are flow diagrams of a method for providing visibility assistance using the vehicle of FIG. 1 and/or the portable device of FIG. 3, according to an exemplary embodiment.

FIGS. 6A-6D depict top views of a golf course where the vehicle of FIG. 1 and/or the portable device of FIG. 3 provide visibility assistance to a golfer on a tee box, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

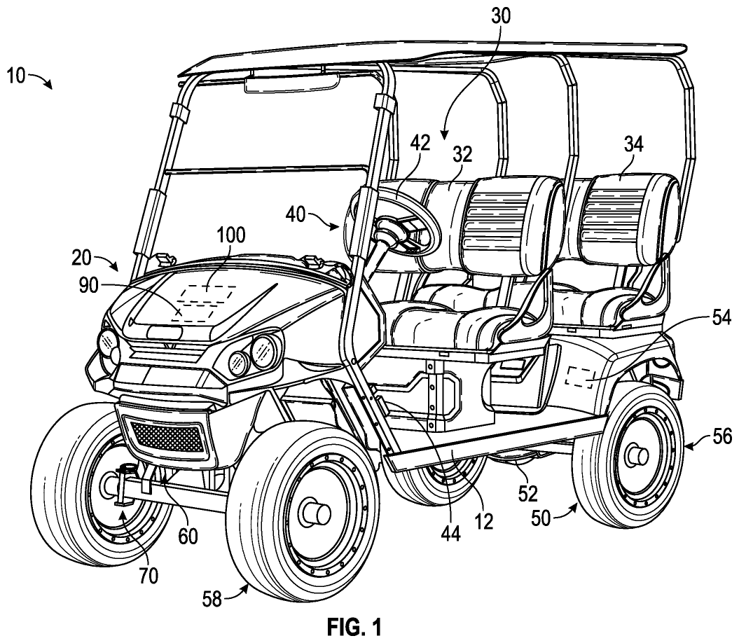

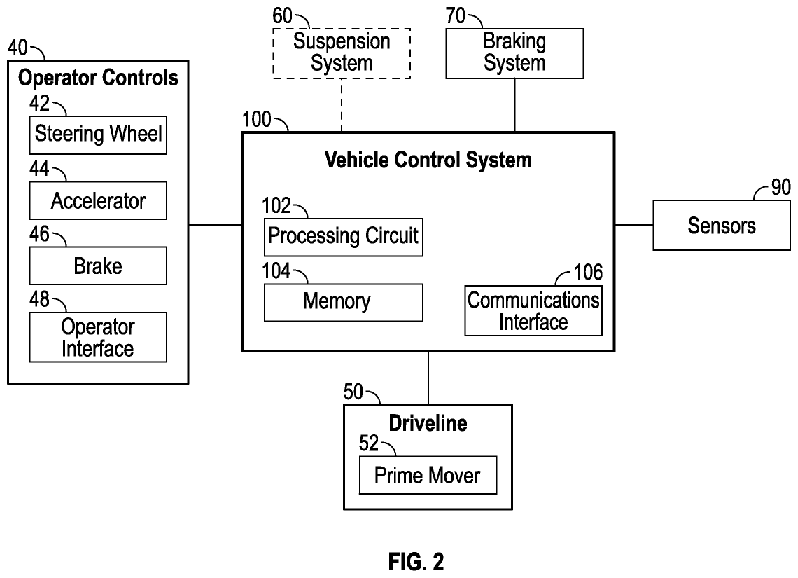

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart, an all-terrain vehicle (“ATV”), a utility task vehicle (“UTV”), a low speed vehicle (“LSV”), a personal transport vehicle (“PTV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system.

According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a Doppler sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein.

According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Portable Device

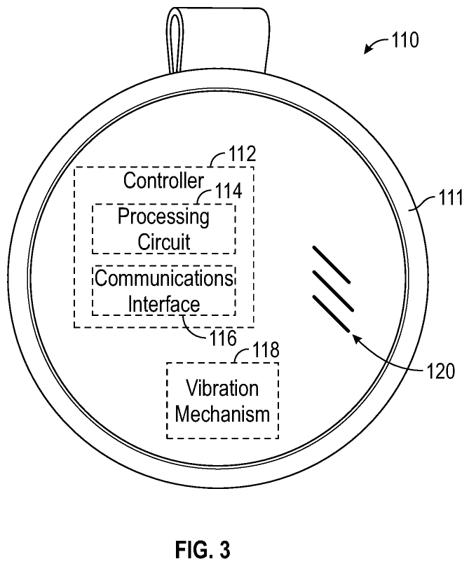

As shown in FIG. 3, a portable device, shown as portable tracker 110, includes a body, shown as housing 111; a controller 112 including a processing circuit 114 and a communications interface 116; a haptic feedback device, shown as vibration mechanism 118; and an audio feedback device, shown as speaker 120. The portable tracker 110 may be a tracking device carried by a golfer during a round of golf. The portable tracker 110 may be configured to track position and/or movements of a golfer, pace of play, statistics associated with the golfer, and so on.

The controller 112 may be implemented as a general-purpose processor, an ASIC, one or more FPGAs, a DSP, circuits containing one or more processing components, circuitry for supporting a microprocessor, a group of processing components, or other suitable electronic processing components. The processing circuit 114 may include an ASIC, one or more FPGAs, a DSP, circuits containing one or more processing components, circuitry for supporting a microprocessor, a group of processing components, or other suitable electronic processing components.

In one embodiment, the controller 112 is configured to selectively engage, selectively disengage, control, or otherwise communicate with components of the portable tracker 110 (e.g., via the communications interface 116, a controller area network (“CAN”) bus, etc.). According to an exemplary embodiment, the controller 112 is coupled to (e.g., communicably coupled to) the vibration mechanism 118, the speaker 120, and the remote systems 240. By way of example, the controller 112 may send and receive signals (e.g., control signals, location signals, etc.) with the vibration mechanism 118, the speaker 120, and/or the remote systems 240 (via the communications interface 116 as described in greater detail herein). The vibration mechanism 118 may be configured to, in response to a signal from the controller 112, cause a haptic or vibrational movement or feedback of the portable tracker 110. In some embodiments, a frequency of the vibrational movement may depend on the signal received from the controller 112. Alternatively or additionally, the frequency of the vibrational movement may depend on one or more user preferences defined by a user (e.g., a golfer) of the portable tracker 110.

Similarly, the speaker 120 may be configured to, in response to a signal from the controller 112, generate an audible output from the portable tracker 110. In some embodiments, a sound of the audible output may depend on the signal received from the controller 112. Alternatively or additionally, the sound of the audible output may depend on the one or more user preferences defined by the user of the portable tracker 110.

### Site Monitoring and Control System

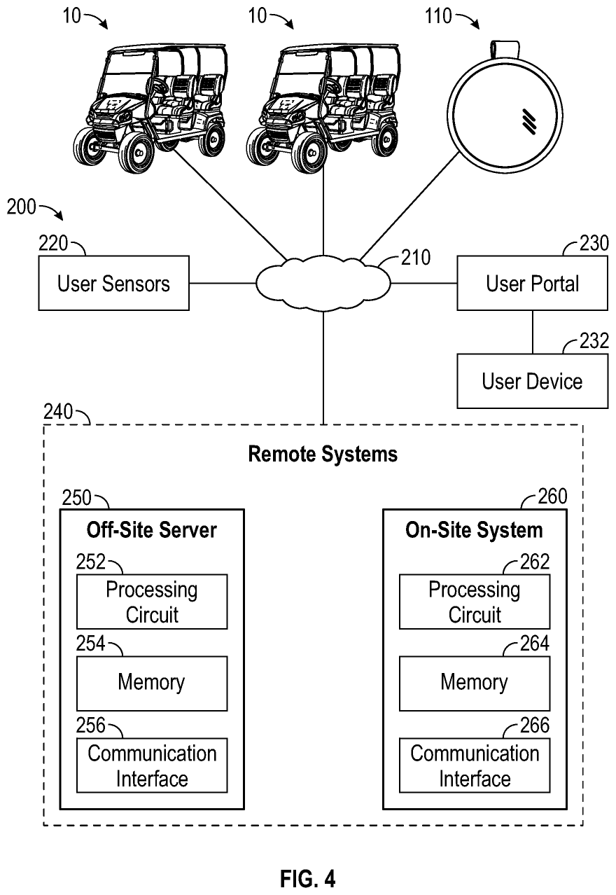

As shown in FIG. 4, a monitoring and control system, shown as site monitoring and control system 200, includes one or more vehicles 10; one or more portable trackers 110 (although FIG. 4 illustrates one portable tracker 110, it should be appreciated that the site monitoring and control system 200 may include a plurality of portable trackers 110); one or more second sensors, shown as user sensors 220, positioned remote or separate from the vehicles 10 and the portable trackers 110; an operator interface, shown as user portal 230, positioned remote or separate from the vehicles 10 and the portable trackers 110; an external or remote user device, shown as user device 232, positioned remote or separate from the vehicles 10 and the portable trackers 110; and one or more external processing systems, shown as remote systems 240, positioned remote or separate from the vehicles 10 and the portable trackers 110. In some embodiments, the portable trackers 110 and the user sensors 220 are one in the same. The vehicles 10, the portable trackers 110, the user sensors 220, the user portal 230, and the remote systems 240 communicate via one or more communications protocols (e.g., Bluetooth, Wi-Fi, cellular, radio, through the Internet, etc.) through a network, shown as communications network 210. In some embodiments, the site monitoring and control system 200 does not include the user portal 230 and/or the user device 232.

The user sensors 220 may be or include one or more sensors that are carried by or worn by an operator of one of the vehicles 10 and/or by a user of one of the portable trackers 110. By way of example, the user sensors 220 may be or include a wearable sensor (e.g., a smartwatch, a fitness tracker, a pedometer, a heart rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the portable trackers 110, directly with the remote systems 240, and/or indirectly with the remote systems 240 (e.g., through the vehicles 10 and/or the portable trackers 110 as an intermediary).

The user portal 230 may be configured to facilitate operator access to dashboards including the vehicle data from the vehicles 10, device data from the portable trackers 110, the operator data, information available at the remote systems 240, etc. to manage and operate the site (e.g., golf course) such as for advanced scheduling purposes, to identify persons breaking course guidelines or rules, to monitor locations of the vehicles 10, to monitor locations of the portable trackers 110, etc. The user portal 230 may also be configured to facilitate operator implementation of configurations and/or parameters for the vehicles 10, the portable trackers 110, and/or the site (e.g., setting speed limits, setting geofences, etc.). As shown in FIG. 4, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 4, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 4, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10, the portable trackers 110, and/or the user sensors 220 via the communications network 210. By way of example, the remote systems 240 may receive the vehicle data from the vehicles 10, the device data from the portable trackers 110, and/or the operator data from the user sensors 220. The remote systems 240 may be configured to perform back-end processing of the vehicle data, the device data, and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10, the portable trackers 110, and/or the user sensors 220. The remote systems 240 may be configured to transmit information, data, commands, and/or instructions to the vehicles 10 and/or the portable trackers 110. By way of example, the remote systems 240 may be configured to transmit GPS data and/or RTK data based on the GPS information and/or RTK information to the vehicles 10 and/or the portable trackers 110 (e.g., which the vehicle control systems 100 may use to make control decisions). By way of another example, the remote systems 240 may send commands or instructions to the vehicles 10 and/or the portable trackers 110 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10, the portable trackers 110, and/or the operators/users thereof and/or (b) configuring or setting operating parameters for the vehicles 10 (e.g., geofences, speed limits, times of use, permitted operators, etc.) and/or the portable trackers 110 (e.g., vibrational feedback, audible alerts, etc.). Such operating parameters may be propagated to the vehicles 10 and/or the portable trackers 110 by the remote systems 240 (e.g., as updates to settings) and/or used for real time control of the vehicles 10 and/or the portable trackers 110 by the remote systems 240.

### Visibility Assistance

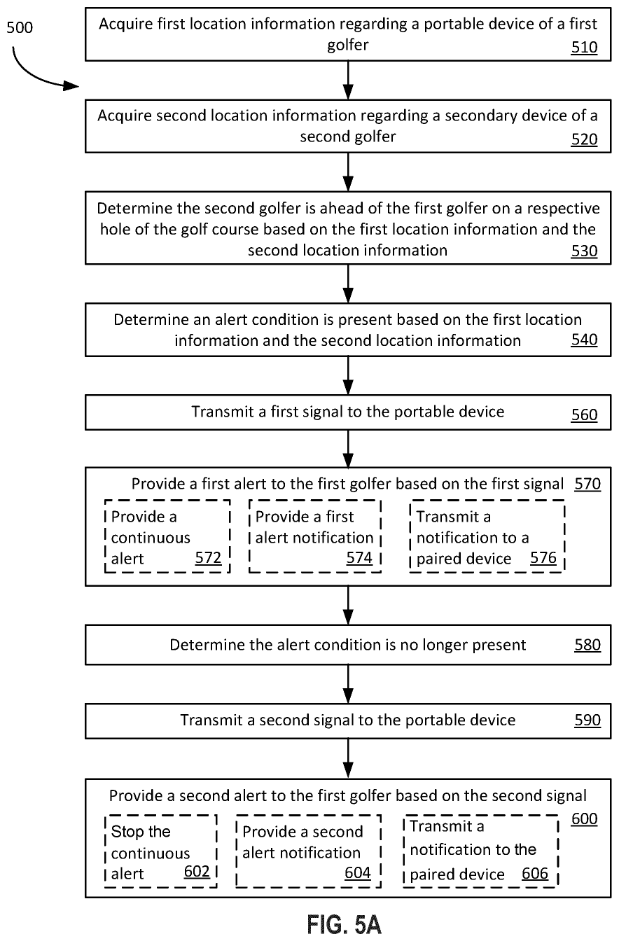

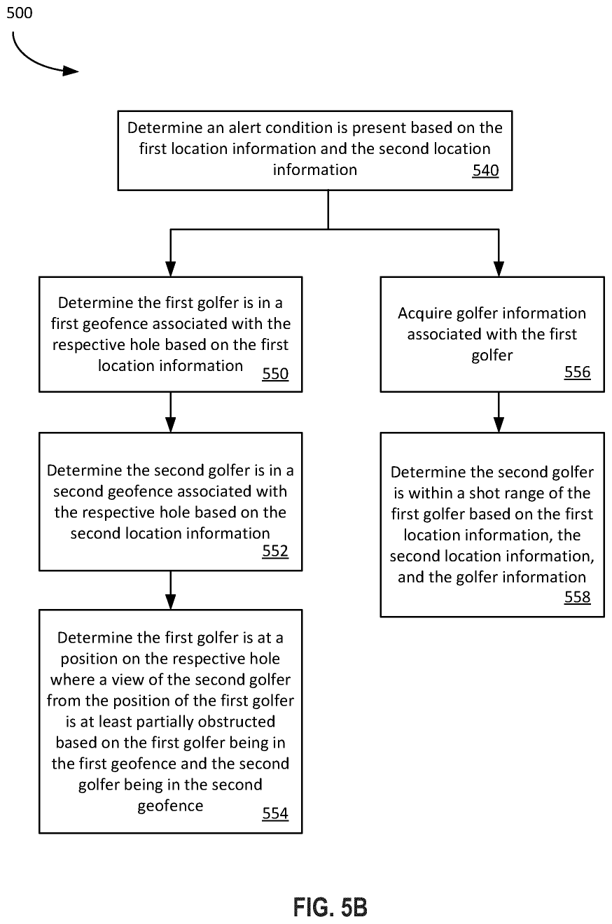

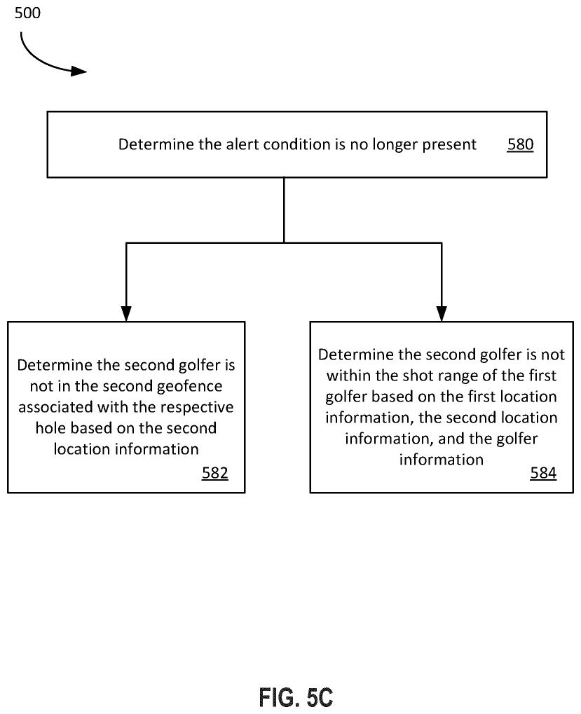

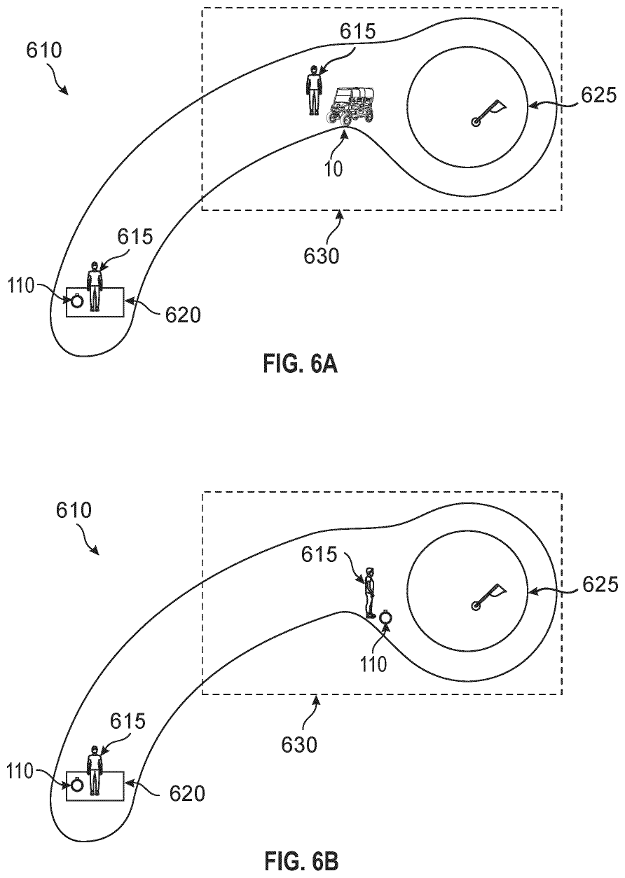

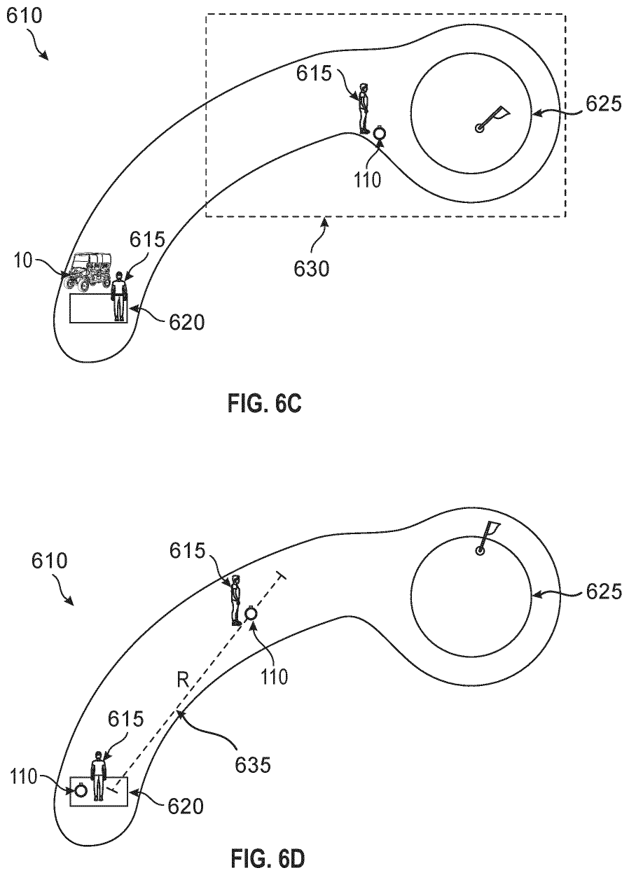

According to an exemplary embodiment, the site monitoring and control system 200 is configured to facilitate providing visibility assistance when a golfer's view of another golfer is obstructed, when a golfer is within a shot range of another golfer, in other scenarios where a golfer is at risk of being struck by another golfer's golf ball, and so on. FIGS. 5A-5C depict a method 500 for providing visibility assistance using the vehicle of FIG. 1 and/or the portable device of FIG. 3, according to an exemplary embodiment. The method 500 may be applicable to the various scenarios depicted on a golf course 610 shown in FIGS. 6A-6D. As shown, the various scenarios may include a golfer 615 associated with a portable tracker 110 (e.g., as shown in FIGS. 6A-6B and 6D) or a golfer 615 associated with a vehicle 10 (e.g., as shown in FIG. 6C) positioned at a tee box 620 on the golf course 610. In the various scenarios shown in FIGS. 6A-6D, the golfer 615 may be preparing to hit a tee shot from the tee box 620 towards a putting green 625 on a respective hole of the golf course 610.

Referring to FIG. 5A, the method 500 begins with acquiring first location information regarding a portable device of a first golfer at step 510. The portable device may be the portable tracker 110 and/or the user sensors 220, as described herein. In such embodiments, the first location information may be received by the remote systems 240 as a GPS position of the portable tracker 110. For example, as shown in FIGS. 6A-6B and 6D, the first location information may be regarding the portable tracker 110 associated with the golfer 615 located at the tee box 620. Alternatively or additionally, the first location information acquired at step 510 of method 500 may relate to a vehicle (e.g., the vehicle 10) operated by the first golfer. For instance, as shown in FIG. 6C, the vehicle 10, which may be operated by the golfer 615, is located at the tee box 620.

As shown in FIG. 5A, the method 500 continues with acquiring second location information regarding a secondary device of a second golfer at step 520 and determining that the second golfer is ahead of the first golfer on the respective hole of the golf course based on the first location information and the second location information at step 530. That is, while the first golfer is preparing to hit a tee shot from the tee box 620 towards the putting green 625 on the respective hole of the golf course 610, the second golfer may be positioned on the respective hole of the golf course 610 between the tee box 620 and the putting green 625. In some embodiments, the secondary device may be a vehicle 10 (e.g., shown in FIG. 6A) operated by the golfer 615. Alternatively or additionally, the secondary device may be a second portable tracker 110 (e.g., a portable tracker 110 that is distinct from the portable tracker 110 relating to the location information acquired in step 510) carried by the second golfer. For example, FIGS. 6A-6D depict scenarios where the secondary device may be the portable tracker 110 associated with the golfer 615.

As shown in FIG. 5A, the method 500 includes determining an alert condition is present based on the first location information and the second location information at step 540. The alert condition refers to a circumstance on the golf course 610 in which a golfer's view of another golfer is obstructed, a golfer is within a shot range of another golfer, a golfer is otherwise at risk of being struck by another golfer's golf ball, and so on. That is, the alert condition necessitates providing a warning to a golfer in order for the golfer to avoid hitting another golfer. The alert condition may be determined based on a geofence (e.g., geofence 630, as shown in FIGS. 6C) and/or a shot range (e.g., range 635, as shown in FIG. 6D) of a golfer preparing to take a tee shot from the tee box 620.

FIG. 5B shows additional steps of the method 500 for determining the alert condition is present at step 540. As shown, determining the alert condition is present at step 540 may include determining the first golfer is in a first geofence associated with the respective hole based on the first location information at step 550. For example, in the scenarios shown in FIGS. 6A-6C, the first geofence may include the tee box 620. After determining that the first golfer is in the first geofence, the method 500 continues by determining the second golfer is in a second geofence associated with the respective hole based on the second location information at step 552. Continuing with the scenarios depicted in FIGS. 6A-6C, the second geofence may be the geofence 630 (e.g., a region on and around the golf course 610 defined by the dashed box, as shown). In some embodiments, the geofence 630 is defined via the user portal 230. After determining that the first golfer is within the first geofence and that the second golfer is within the second geofence, the alert condition may be determined as being present by determining that the first golfer is at a position on the respective hole where a view of the second golfer from the position of the first golfer is or may be at least partially obstructed at step 554. As shown in FIGS. 6A-6C, the alert condition is present because the second golfer (e.g., the golfer 615 positioned between the tee box 620 and the putting green 625) is within the geofence 630.

Alternatively or additionally, the alert condition may be determined as being present based on a shot range of the first golfer. That is, step 540 may include acquiring golfer information associated with the first golfer at step 556. The golfer information may include a shot range of the first golfer. The shot range refers to a distance reachable by a shot of the first golfer. The shot range of the first golfer may be part of a golfer profile associated with the first golfer. The shot range may be user defined or based on past performance on the hole by the first golfer. For example, in FIG. 6D, the distance reachable by a tee shot of the golfer 615 is shown as range 635. In other words, the golfer 615 is capable of driving from the tee box 620 to the end of the range 635. Based on the shot range, the alert condition may be determined as being present by determining that the second golfer is within the shot range of the first golfer based on the first location information, the second location information, and the golfer information at step 558. As shown in FIG. 6D, the second golfer (e.g., the golfer 615 positioned in a fairway on the golf course 610) is within the shot range (e.g., the range 635) of the first golfer (e.g., the golfer 615 positioned at the tee box 620). In this scenario, the alert condition is present because the second golfer is within the shot range of the first golfer. In some embodiments, the alert condition is present based on the second golfer being within the geofence 630 and within the range 635.

Referring back to FIG. 5A, after is it determined that the alert condition is present based on at least one of the geofence 630 or the range 635, the method 500 continues by transmitting a first signal to the portable device (e.g., the portable tracker 110) associated with the first golfer. For example, the first signal may be transmitted by the remote systems 240 to the portable tracker 110 via the communications network 210. In some embodiments, the remote systems 240 may transmit the first signal to the portable tracker 110 based on the determination that the first golfer 615 is at the position on the respective hole where the view of the second golfer 615 from the position of the first golfer 615 (e.g., at the tee box 620) is at least partially obstructed (e.g., as determined by steps 550-554, described above with reference to FIG. 5B). Alternatively or additionally, the remote systems 240 may transmit the first signal to the portable tracker 110 based on the determination that the second golfer 615 is within the range 635 of the first golfer 615 (e.g., as determined by steps 556 and 558, described above with reference to FIG. 5B).

In response to receiving the first signal, the portable device (e.g., the portable tracker 110) is configured to provide a first alert to the first golfer at step 570. The first alert is configured to warn the first golfer regarding the second golfer by at least one of an audible notification via the speaker 120 or a vibrational notification via the vibration mechanism 118. In some embodiments, providing the first alert at step 570 includes at least one of providing a continuous alert at step 572, providing a first alert notification at step 574, or transmitting a notification to a paired device at step 576. The continuous alert refers to an audible output (e.g., a beep, intermittent beeping, a tone, etc.), a vibration, etc. that may persist until the alert condition is no longer present and the portable device receives a second signal (e.g., as described below with reference to step 590 of method 500). It should be understood that continuous may mean a periodic or constant audible output or vibration that persists until the alert condition is no longer present. The first alert notification may refer to a one-time audible output, vibration, etc. from the portable device to warn the first golfer. The notification to the paired device may refer to a message (e.g., a text message, an email, a push notification, an audible output, a haptic/vibrational output, etc.) sent to another device associated with the first golfer and paired to the portable device and present on the golf course 610 (e.g., a smartphone, a watch, a tablet, etc.).

In some embodiments, where the first location information is received from the vehicle 10 being driven by the first golfer rather than from a portable tracker 110 (e.g., as shown in FIG. 6C), the first alert may be provided to the vehicle 10. For example, the first alert may be provided as a message via a display screen on the vehicle 10, as an audible output from the vehicle 10, as a notification transmitted to a paired device, etc. In some embodiments, operation of the vehicle 10 may be suspended until the alert condition is no longer present and the vehicle 10 receives a second signal (e.g., at step 590).

Method 500 continues by determining that the alert condition is no longer present at step 580. FIG. 5C illustrates additional steps for determining that the alert condition is no longer present at step 580. That is, if the alert condition determined at step 540 includes the second golfer being in the second geofence (e.g., the geofence 630, as determined during steps 550-554 of method 500), the method 500 may continue by determining that the second golfer is not in the second geofence associated with the respective hole based on the second location information at step 582. Alternatively or additionally, if the alert condition determined at step 540 includes the second golfer being in the shot range of the first golfer (e.g., the range 635, as determined during steps 556 and 558 of method 500), the method 500 may continue by determining that the second golfer is not within the shot range of the first golfer based on the first location information, the second location information, and the golfer information at step 584. In some embodiments, where the second golfer is determined to be within the second geofence and within the shot range of the first golfer, determining that the alert condition is no longer present at step 580 may include determining that the second golfer is not in the second geofence (e.g., step 582) and/or determining that the second golfer is not within the shot range of the first golfer (e.g., step 584).

Referring back to FIG. 5A, after is it determined that the alert condition is no longer present, the method 500 continues by transmitting a second signal to the portable device (e.g., the portable tracker 110). For example, the second signal may be transmitted by the remote systems 240 to the portable tracker 110 via the communications network 210. In some embodiments, the remote systems 240 transmit the second signal to the portable tracker 110 based on the determination that the second golfer 615 is no longer at a position on the respective hole where the view of the second golfer 615 from the position of the first golfer 615 (e.g., at the tee box 620) is at least partially obstructed (e.g., as determined by step 582, described above with reference to FIG. 5C). Alternatively or additionally, the remote systems 240 may transmit the second signal to the portable tracker 110 based on the determination that the second golfer 615 is no longer within the range 635 of the first golfer 615 (e.g., as determined by step 584, described above with reference to FIG. 5C).

In response to receiving the second signal, the portable tracker 110 may provide a second alert to the first golfer at step 600. The second alert is configured to notify the first golfer that the second golfer is no longer at risk of being struck by a shot from the first golfer. In some embodiments, providing the second alert at step 600 may include at least one of stopping the continuous alert at step 602, providing a second alert notification at step 604, or transmitting a notification to the paired device at step 606. The second alert notification may refer to a one-time audible output, vibration, etc. from the portable tracker 110 to notify the first golfer that it is safe to proceed. In some embodiments, the first alert notification and the second alert notification are the same or similar (e.g., the same sound or tone, the same vibrational pattern, etc.). In some embodiments, the first alert notification and the second alert notification are different (e.g., different audio messages (e.g., “warning,” “caution,” “do not shoot,” “golfer ahead,” etc. vs. “all clear,” “ready to shoot,” etc.) different sounds, different vibrational patters, etc.). The notification to the paired device may refer to a message (e.g., a text message, an email, a push notification, an audible output, a haptic/vibrational output, etc.) sent to another device associated with the first golfer and present on the golf course 610 (e.g., a smartphone, a watch, a tablet, etc.).

In some embodiments, where the first location information is received from the vehicle 10 being driven by the first golfer rather than from a portable tracker 110 (e.g., as shown in FIG. 6C), the second alert may be provided to the vehicle 10. For example, the second alert may be provided as a message via a display screen on the vehicle 10, as an audible output from the vehicle 10, as a notification transmitted to a paired device, the removal or stopping of the notification, etc. If operation of the vehicle 10 was previously suspended in response to receiving the first signal at step 560, operation of the vehicle 10 may resume in response to receiving the second signal at step 600.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.), the portable trackers 110, and the site monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A golf lookahead system for a golf course, the golf lookahead system comprising:
a portable device configured to be carried by a first golfer; and
a server configured to communicably couple with the portable device and a secondary device associated with a second golfer, the server configured to:
acquire first location information regarding the portable device;
determine the first golfer is in a first geofence associated with a respective hole based on the first location information;
acquire second location information regarding the secondary device;
determine the second golfer is in a second geofence associated with the respective hole based on the second location information;
determine the second golfer is ahead of the first golfer on the respective hole of the golf course based on the first location information and the second location information;
determine an alert condition is present based on the first location information and the second location information;
determine the first golfer is at a position on the respective hole where a view of the second golfer from the position of the first golfer is at least partially obstructed based on the first golfer being in the first geofence and the second golfer being in the second geofence;
transmit a first signal to the portable device based on the determination that the first golfer is at the position on the respective hole where the view of the second golfer from the position of the first golfer is at least partially obstructed, wherein the portable device is configured to warn the first golfer regarding the second golfer in response to the first signal to prevent the first golfer from taking a shot;
determine the alert condition is no longer present; and
transmit a second signal to the portable device, wherein the portable device is configured to notify the first golfer that the shot can be taken in response to the second signal.

2. The golf lookahead system of claim 1, wherein the secondary device is a golf cart configured to be driven by the second golfer.

3. (canceled)

4. The golf lookahead system of claim 1, wherein determining the alert condition is no longer present includes determining the second golfer is not in the second geofence associated with the respective hole based on the second location information.

5. The golf lookahead system of claim 1, wherein the server is configured to:
acquire golfer information associated with the first golfer, the golfer information including a shot range of the first golfer;
determine the second golfer is within the shot range of the first golfer based on the first location information, the second location information, and the golfer information; and
transmit the first signal to the portable device based on the determination that the first golfer is at the position on the respective hole where the view of the second golfer from the position of the first golfer is at least partially obstructed and based on the determination that the second golfer is within the shot range of the first golfer.

6. The golf lookahead system of claim 5, wherein determining the alert condition is no longer present includes:
determining the second golfer is not in the second geofence associated with the respective hole based on the second location information; and
determining the second golfer is not within the shot range of the first golfer based on the first location information, the second location information, and the golfer information.

7. (canceled)

8. (canceled)

9. The golf lookahead system of claim 1, wherein the portable device includes at least one of a speaker or a vibration mechanism.

10. The golf lookahead system of claim 9, wherein the portable device is configured to warn the first golfer regarding the second golfer via at least one of an audible notification via the speaker or a vibrational notification via the vibration mechanism.

11. The golf lookahead system of claim 1, wherein warning the first golfer regarding the second golfer and notifying the first golfer that the shot can be taken includes providing a continuous warning so long as the alert condition is present.

12. The golf lookahead system of claim 1, wherein warning the first golfer regarding the second golfer includes a first output and notifying the first golfer that the shot can be taken includes a second output.

13. The golf lookahead system of claim 12, wherein the first output and the second output are the same.

14. The golf lookahead system of claim 12, wherein the first output and the second output are different.

15. The golf lookahead system of claim 1, wherein warning the first golfer regarding the second golfer and notifying the first golfer that the shot can be taken includes providing a notification signal to a third device paired with the first device.

16. A golf lookahead system for a golf course, the golf lookahead system comprising:
one or more processors configured to:
acquire first location information regarding a first device associated with a first golfer;
determine the first golfer is in a first geofence associated with a respective hole based on the first location information;
acquire second location information regarding a secondary device associated with a second golfer, wherein at least one of the first device or the secondary device comprises a portable device;
determine the second golfer is in a second geofence associated with the respective hole based on the second location information;
determine the second golfer is ahead of the first golfer on the respective hole of the golf course based on the first location information and the second location information;
determine an alert condition is present based on the first location information and the second location information;
determine the first golfer is at a position on the respective hole where a view of the second golfer from the position of the first golfer is at least partially obstructed based on the first golfer being in the first geofence and the second golfer being in the second geofence;
transmit a first signal to the first device based on the determination that the first golfer is at the position on the respective hole where the view of the second golfer from the position of the first golfer is at least partially obstructed, wherein the first device is configured to warn the first golfer regarding the second golfer in response to the first signal to prevent the first golfer from taking a shot;
determine the alert condition is no longer present; and
transmit a second signal to the first device, wherein the first device is configured to notify the first golfer that the shot can be taken in response to the second signal.

17. (canceled)

18. (canceled)

19. A golf lookahead system comprising:
a non-transitory computer-readable medium having instructions stored thereon that, when executed by one or more processors, cause the one or more processors to:
acquire first location information regarding a portable device configured to be carried by a first golfer on a golf course;
determine the first golfer is in a first geofence associated with a respective hole based on the first location information;
acquire second location information regarding a secondary device associated with a second golfer on the golf course;
determine the second golfer is in a second geofence associated with the respective hole based on the second location information;
determine the second golfer is ahead of the first golfer on the respective hole of the golf course based on the first location information and the second location information;
determine an alert condition is present based on the first location information and the second location information;
determine the first golfer is at a position on the respective hole where a view of the second golfer from the position of the first golfer is at least partially obstructed based on the first golfer being in the first geofence and the second golfer being in the second geofence;
transmit a first signal to the portable device based on the determination that the first golfer is at the position on the respective hole where the view of the second golfer from the position of the first golfer is at least partially obstructed, wherein the portable device is configured to warn the first golfer regarding the second golfer in response to the first signal to prevent the first golfer from taking a shot;
determine the alert condition is no longer present; and
transmit a second signal to the portable device, wherein the portable device is configured to notify the first golfer that the shot can be taken in response to the second signal.

20. The golf lookahead system of claim 19, wherein the instructions cause the one or more processors to:
determine the second golfer is within a shot range of the first golfer based on the first location information and the second location information;
transmit the first signal to the first device based (a) the determination that the first golfer is at the position on the respective hole where the view of the second golfer from the position of the first golfer is at least partially obstructed and (b) the determination that the second golfer is within the shot range of the first golfer.

21. The golf lookahead system of claim 1, wherein the portable device is a first portable device and the secondary device is a second portable device configured to be carried by the second golfer.

22. The golf lookahead system of claim 1, wherein the portable device is configured to provide a continuous warning until an input is received to stop the warning.

23. The golf lookahead system of claim 1, wherein the portable device does not include a display screen.
